(19) United States
(12) Patent Application Publication
(10) Pub. No.: US 2006/0272633 A1
(43) Pub. Date: Dec. 7, 2006

(54) Safe turkey deep fryer

(76) Inventor: Jovito M. Osias JR., Sewell, NJ (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/144,887

(22) Filed: Jun. 3, 2005

(51) Int. Cl. A47J 27/58

(52) U.S. Cl. 126/383.1; 99/355

(57) ABSTRACT

A deep frying apparatus for turkeys and other food items comprising a cauldron, an overflow sleeve integral to the cauldron, and a drain basin connected to the overflow sleeve via a flexible conduit. The cauldron is shaped as an elliptical cylinder thereby approximating the shape of a turkey and reducing the amount of cooking oil necessary. Support stands providing additional safety features are also disclosed. In an alternative embodiment, the apparatus of the present invention is used for steaming food items where the overflow sleeve, conduit, and drain basin are used for collecting excess condensate from the steaming operation.

### CROSS REFERENCE TO RELATED APPLICATION

This application is a continuation-in-part of U.S. patent application Ser. No. ______, filed Mar. 23, 2005 entitled SAFE TURKEY DEEP FRYER.

### FIELD OF INVENTION

The present invention generally relates to an apparatus used to deep fry large food items. In particular, the present invention is a deep fry apparatus for frying turkeys which contains a sleeve to prevent hot overflow onto the stove.

### BACKGROUND

Deep frying of food items has always been hazardous. Hot oil can be very dangerous, especially when splashing out of the cooking apparatus. When a fryer is operated with a lid, condensate from the frying operation can drip into the hot oil causing splatter. Oil is flammable, and it is therefore necessary to keep spattered and spilled oil away from the cooking heat source. There have been a number of patents directed to deep fryers.

U.S. Pat. No. 6,711,992 is directed toward a fryer with a basket featuring a main body with a product capture reception area, a side wall, a bailing extension fixed to the side wall, and a capture hook device fixed to the side wall. The capture hook device includes capture hook sections that are circumferentially spaced about the circumference of the main body of the basket and designed to engage a pot configured to receive the basket. The invention also includes a drain valve secured to the pot for drain off of cooking fluid. The combination of the basket capture device for draining cooking fluid and the drain thus provides a low mess cooking apparatus.

U.S. Pat. No. 6,677,556 is directed toward an inner pot of an electric fryer which includes an annular electric heating tube at the bottom. Two ends of the electric heating tube are separated from each other, forming there between a gap that forms the coolest section of the inner circumference at the bottom of the inner pot. An oil gathering groove is provided at the coldest section and communicates with the bottom center of the inner pot by means of an oil passage passing through the gap between the two ends of the electric heating tube. The inner pot is designed to have a bottom slanting downward toward the oil-gathering groove. Thus, the remaining oil in the inner pot is able to flow into the oil gathering groove along the inner wall and through the oil passage to prevent remaining oil inside from accumulating near the electric heating tube and catching fire.

U.S. Pat. No. 6,446,545, to Rigney, is directed toward a cooking apparatus including a container, a spigot, a lid, and a food support. The container has a bottom surface and a side wall that extends upwardly from the bottom surface to a top edge of the side wall. The spigot is attached to the container side wall and has a valve member that is selectively positionable between opened and closed positions. The spigot valve member allows liquid contents of the container to drain from the container when in the opened position, and prevents the contents from draining out of the container when in the closed position. The food support comprises a perforated horizontal member with a perforated side wall extending upwardly from the horizontal member. A plurality of vertical members spaced around the periphery of the horizontal member extend upwardly from the horizontal member. The food support is dimensioned to fit within the interior of the container and some of the vertical members have top ends with integral support connectors that are adapted to engage with the side wall top edge to suspend the food support in a spaced relation from the container bottom surface.

U.S. Pat. No. 5,033,453, to Loyd et al., is directed toward an overflow cooking pot assembly comprising a main support pan member, an intermediate lid member, and a main outer lid member. The main support pan member is provided with a main support section integral with a fluid overflow section extending laterally and upwardly there from. The intermediate lid member is provided with vent slots to permit overheated fluid or food product to move into the fluid overflow section for cooling thereof. Another embodiment of the invention includes the basic cooking pot assembly having a double boiler cooking pot assembly connected thereto. The double boiler cooking pot assembly includes a support and spacer member and a double boiler pan member. The support and spacer member is mountable within the main support pan member to receive the double boiler pan member mounted thereon to allow the heated liquids to flow there between. Another embodiment involves a fryer cooking pot assembly usable with the basic cooking pot assembly with the same spacer member and a screened fryer member. The support and spacer member allows the cooking oil to flow between the main support pan member and the screened fryer member. Another embodiment involves a food steamer cooking pot assembly having a food steamer member mountable on a support and spacer member for a food cooking steaming operation.

U.S. Patent Application No. 20030029323, to Ehlhardt, is directed toward an apparatus for deep frying food, including a transparent window which takes up at least a portion of a cover and which extends vertically, or at least partially at an angle. A vapor discharge channel communicates with the inner space of the pan. A cooling surface is provided for cooling vapor, which communicates with the inner space via the vapor discharge channel. A storage reservoir is used for storing condensate that has condensed on the cooling surface, and a collecting gutter serves for collecting condensate from the window. The collecting gutter extends along a bottom end of the window and includes a drain, via which drain the collecting gutter communicates also with the vapor discharge channel for draining condensate to the vapor discharge channel. Furthermore, a provision for signaling deep-frying activity in response to heating by hot vapor is described.

U.S. Design Patent No. D486,689 to Davis, is directed toward an ornamental design for a turkey fryer stand.

While fryers have appeared in the prior art, there is a need for a fryer which will prevent fires caused by cooking oil overflow. There is also a need for a deep flyer large enough for items such as turkeys and chickens that can reduce the likelihood of fire caused by spatter, tipping, and overflow of cooking oil from the fryer.

### SUMMARY

The present invention is a deep frying apparatus for turkeys and other food items that comprises a cauldron for holding the cooking oil and the food item to be fried, an overflow sleeve integral to the cauldron that receives overflow cooking oil, oil spatter, and condensate, and a drain basin connected to the overflow sleeve via a flexible conduit for receiving the overflow, spatter, and condensate. The cauldron is preferably shaped as an elliptical cylinder thereby approximating the shape of a turkey and reducing the amount of cooking oil required. Support stands providing additional safety features are also disclosed. In an alternative embodiment, the apparatus of the present invention is used for steaming food items where the overflow sleeve, conduit, and drain basin are used for collecting excess condensate from the steaming operation.

### BRIEF DESCRIPTION OF THE DRAWINGS

FIG. 1 is a side view of the turkey fryer apparatus of the present invention.

FIG. 2 is a perspective view of the cauldron with integral overflow sleeve and the support stand of the turkey fryer of the present invention.

FIG. 3 is a perspective view of the support base of the present invention.

FIG. 4 is a top view of the cauldron with integral overflow sleeve and the fry rack inserted therein of the present invention.

FIG. 5 is a top view of a steaming tray supported by the fry rack of the present invention

FIG. 6 is a cutaway side view of the cauldron with the steaming trays inserted therein for steaming in accordance with the present invention.

### DETAILED DESCRIPTION OF THE PREFERRED EMBODIMENTS

The present invention will be described in more detail with reference to the drawing figures wherein like numerals indicate like elements.

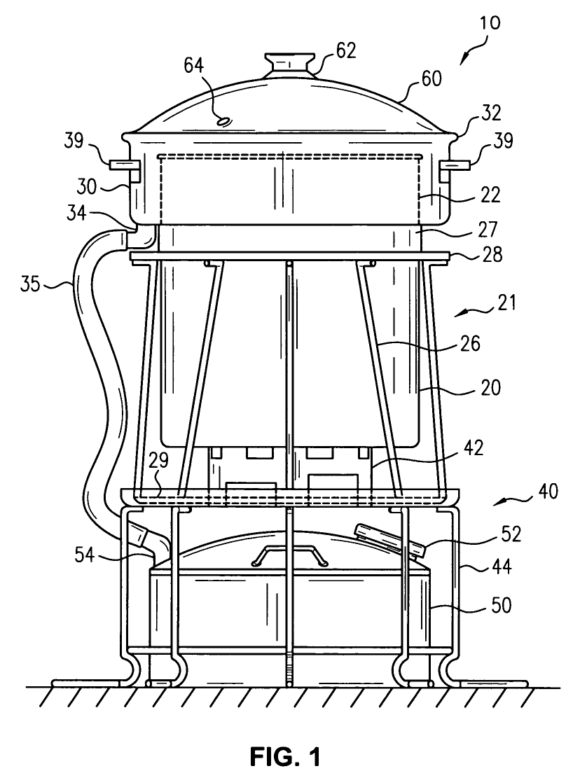

Referring to FIG. 1, an elevation view of the turkey fryer apparatus 10 of the present invention is shown. The turkey fryer apparatus 10 comprises a cauldron 20, an overflow sleeve 30, a support stand 21, a support base 40, and a drain basin 50 connected to the overflow sleeve 30 via a conduit 35. A heat source 42 is situated on the support base 40, and provides heat for the cooking process. The apparatus 10 has several safety features to prevent hot oil from injuring the operator or contacting the heat source resulting in a fire.

The cauldron 20 is preferably constructed from a material that is a good heat conductor. Copper, aluminum, and stainless steel are all excellent heat conductors and are durable to withstand the cleaning and frying of food products. Aluminum is advantageous in that it will allow an electric heating element to be constructed integral to the base of the cauldron. Furthermore, aluminum accepts a coating of polytetrafluoroethylene (PTFE), a non-stick coating commonly used to coat cooking utensils and cauldrons, on the interior of the cauldron to prevent staining and promote cleaning. Aluminum is also relatively lightweight, allowing for easy user operation, including emptying used cooking oil from the cauldron.

The shape of the cauldron 20 is preferably an elliptical cylinder. The elliptical cauldron 20 approximates the shape of a regular turkey. Compared to a typical circular cylinder shaped cauldron, the elliptical cauldron is advantageous because it requires less cooking oil to cover and fry the turkey contained therein.

The overflow sleeve 30 is designed to catch spatter and overflow from the cauldron 20. The sleeve extends laterally and upwardly from a position on the exterior wall of the cauldron 20. The overflow sleeve 30 is distanced from the heat source 42 and provides a cooling function to any material received therein. The overflow sleeve's rim 32 is preferably taller than the cauldron's rim 22. The overflow sleeve is preferably constructed of the same material as the cauldron 20, and permanently attached thereto by welding or brazing, for example. Alternatively, a single casting incorporating the cauldron 20 and overflow sleeve 30 is possible.

A lid 60 covers the apparatus while in use. The lid 60 is of an arcuate shape, with the highest point of the dome aligned with the center of the cauldron 20. The domed lid 60 contains condensate and splattered oil within the apparatus, away from the heating source. Furthermore, the domed shape of the lid 60 transports condensate and oil to the outer periphery of the lid 60 where it will drip and coalesce in the overflow sleeve 30. The lid 60 material may be the same as the cauldron, or alternatively may be glass or another transparent material. When the material of the lid 60 is glass, a metal rim on the periphery of the lid is preferred. The lid 60 further has a handle 62 atop the dome, or a plurality of handles located elsewhere on the dome. The handle is designed to dissipate heat. This is achieved, for example, with handles made from a thermoplastic material with a low thermal conductivity.

The lid 60 preferably has a pluggable hole 64 allowing the insertion of a thermometer or other temperature measuring instrument there through.

A conduit 35 connects the overflow sleeve 30 to the drain basin 50. Preferably, the conduit 35 is made from a flexible thermoplastic material that is resilient to damage or deformation at high temperatures, such as high temperature silicone rubber tubing. The conduit 35 is removable at both ends, facilitating cleaning. The flexible nature of the conduit 35 allows the separation of the cauldron 20 from the support base 40 without the need to remove the conduit 35. The overflow sleeve 30 has an outlet 34 for connection to the conduit 35. The outlet 34 can be plugged when the conduit 35 is not in use. The outlet 34 is tapered at the end allowing for easy securement of the conduit 35. The drain basin 50 has a similar inlet 54 for receiving the conduit 35. The inlet 54 can also be plugged when the conduit 35 is not in use.

The drain basin 50 has a screw cap 52. An operator of the apparatus 10, when done frying for the day, can remove the screw cap 52 and pour the used cooking oil into the drain basin 50 for storage and later use. The opening covered by the screw cap 52 is preferably large enough to allow cleaning of the drain basin 50 there through.

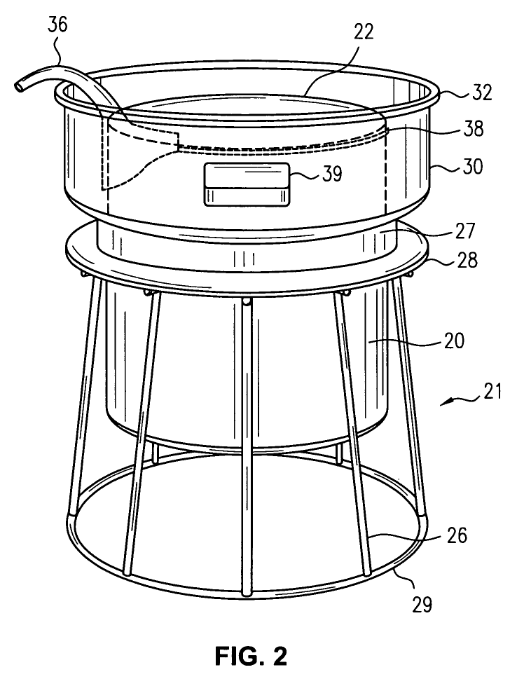

Referring to FIG. 2, the cauldron 20 and overflow sleeve 30 are supported by a support stand 21. A plurality of legs 26 are radially affixed to the vessel support ring 27. The cauldron 20 is inserted into the vessel support ring 27. The lateral portion of the overflow sleeve 30 rests upon the vessel support ring 27. The heat shield 28 extends laterally from the lower end of the vessel support ring 27. The heat shield 28 deflects rising heat from the heat source 42, keeping the overflow sleeve 30 cool. The plurality of legs 26 supporting the cauldron 20 have, at their bottom end, a base ring 29. The base ring 29 provides a flat base for freestanding operation. The support stand 21 allows the user to rest the cauldron 20 on a flat surface. To facilitate pouring of used cooking oil into the drain basin 50, a removable spout 36 is attached to the cauldron 20 immediately below the rim 22. A tightening strap 38 allows the operator to secure the spout 36 to the cauldron 20. Additionally, handles 39 are located on opposite sides of the minor axis of the elliptical overflow sleeve 30. A heat dissipating material, such as a high temperature thermoplastic, or a heat dissipating design is preferred for the handles 39.

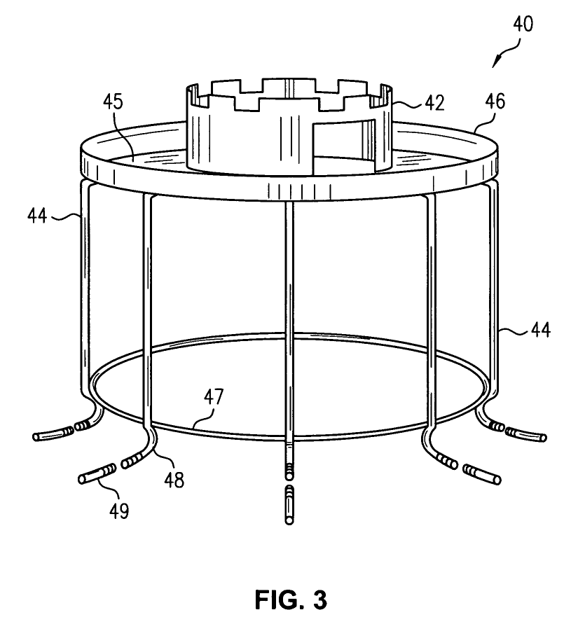

Referring to FIG. 3, a user of the frying apparatus of the present invention can remove the cauldron 20 and the support stand 21 from the support base 40, and thus the heat source 42, for added safety. The support base 40 provides a stable platform for the heat source 42. The support base 40 stands on a plurality of legs 44, with a support ring 47 located at the bottom of the legs 44. The feet 48 have a means for securing a stability extension tube 49 for additional stability. The stability extension tubes 49 may be threaded at one end for mating with a similarly threaded end of the foot 48, for example. The heat source 42 is typically an open flame burner that consumes propane as fuel. An electric heating element or other method of heating is also possible. The heat source 42 is removable from the support base 40 for added safety and alternative uses. When the heat source 42 is an electric heating element, either integral to the cauldron's 20 base or separated there from, a thermostatic controller and a thermostatic safety shutoff switch is preferred. An electric heating element with thermostatic control facilitates the indoor use of the apparatus of the present invention. A thermostatic controller and shutoff switch is also possible with a gas burner for added safety.

The support base 40 has a lip 46 circumferentially attached thereto and extending upward. A horizontal plate 45 receives the base ring 29. The base ring 29 is held from moving laterally by the lip 46. The lip 46 is preferably tall enough to prevent lateral movement of the base ring 29, yet short enough to allow the cauldron 20 to tip over when pushed with a threshold amount of force.

The vast majority of fires caused by fryers result from contacting the cooking oil with the cooking heat source, typically open flame. The interaction of spilled cooking oil and open flame or heat is prevented by allowing the cauldron 20 to tip over independently of the base support 40 and the heat source. However, it should be noted that the cauldron 20 is not designed to be easily tipped off the support base 40. The base ring 29 has a larger diameter than the cauldron 20, which provides stability. A cauldron 20 filled with enough cooking oil to fry a normal sized turkey, approximately 3 to 5 gallons, will weigh between 25 to 50 pounds. Thus, the amount of force required to tip a filled cauldron is significant.

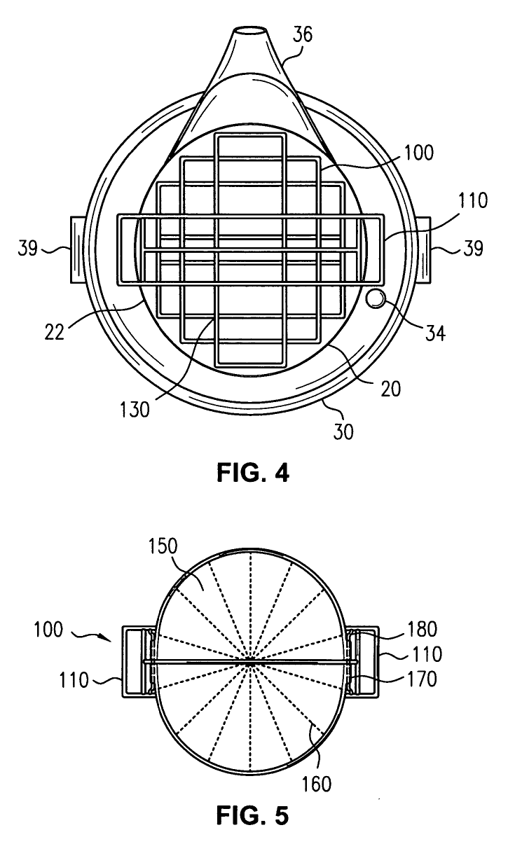

Referring to FIG. 4, a fry rack 100 for supporting food items to be fried is shown. The fry rack 100 has handles 110 allowing a user to lift the food item into and out of the fryer. The handles 110 extend upward from the mesh base 130. The food item to be fried is placed on top of the mesh base 130 and the fry rack 100 is lowered into the cauldron 20, so the mesh base 130 sits on the cauldron's 20 bottom. A further benefit of the elliptical cylinder shaped cauldron 20 is that the fry rack 100 when lifted out of the cauldron 20 can be rotated 90 degrees and set down on the cauldron's rim 22. The cooking oil can thus be drained from the food item and collected in the cauldron 20 and the overflow sleeve 30.

In another embodiment of the present invention, the apparatus may also be used as a food steamer. Referring to FIG. 5, food items to be steamed are placed on a steaming tray 150 which contains many perforations 160. The steaming tray 150 is preferably made from thin aluminum or stainless steel. The steaming tray 150 has an elliptical footprint, matching the shape of the cauldron 20. The plurality of steaming trays 150 have, on their minor axis, a thin tab 170 which engages with a cross bar 180 supported by the fry rack's 100 handles 110.

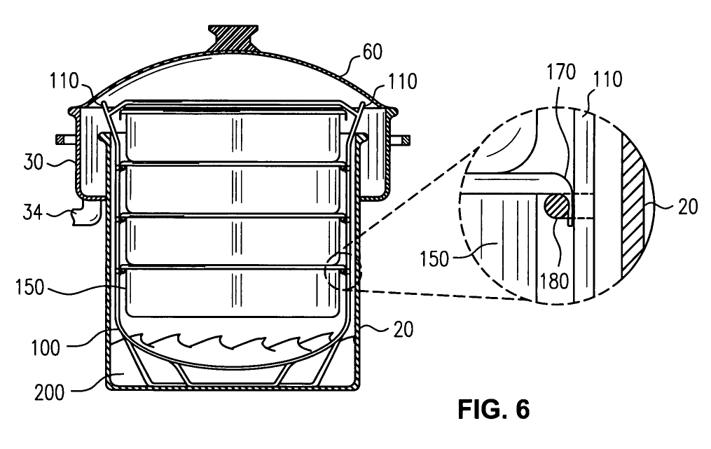

Referring to FIG. 6, a plurality of steaming trays 150 are shown supported by the fry rack 100 and placed inside the cauldron 20. The plurality of steaming trays 150 are stacked for stability. Water 200 is placed in the cauldron 20, and as heat is applied steam is produced. Steam is contained by the lid 60 and condensate is collected in the overflow sleeve 30. The sleeve outlet 34 may be plugged in which case a positive pressure may build inside the cauldron 20 during the steaming operation. The sleeve outlet 34 may alternatively be connected to the drain basin 50 via conduit 35 for condensate collection.

Although the present invention has been described with reference to the preferred embodiments, those skilled in the art will recognize that changes may be made in form and detail without departing from the spirit and scope of the invention.

What is claimed is:

1. An apparatus comprising:
a cauldron, having a bottom and at least one wall with a rim, for containing a liquid and a food item to be heated;
an overflow sleeve for receiving liquid overflow and condensate from the cauldron, the overflow sleeve having a drain outlet; and
a drain basin, having an inlet for receiving overflow from the overflow sleeve.

2. The apparatus of claim 1 further comprising a conduit for coupling to said drain outlet to said drain basin inlet.

3. The apparatus of claim 1 wherein the cauldron has an elliptical shape.

4. The apparatus of claim 2 further comprising:
a support stand for supporting the cauldron, the support stand comprising:
a plurality of legs;
a support ring, attached to said plurality of legs, for supporting the cauldron; and
a heat shield for directing heat away from the cauldron.

5. The apparatus of claim 4 further comprising:
a support base for supporting the support stand and a heat source, the support base comprising:
a plate, having a lip extending upward form the outer peripherary for receiving the support stand and restricting the lateral movement of the support stand, the plate having an opening about its center for access and control of a heating source; and
a plurality of legs attached to and extending downward from the plate.

6. The apparatus of claim 1 wherein the cauldron and the sleeve are made from aluminum, and the interior surface of the cauldron is coated with PTFE.

7. The apparatus of claim 1 further comprising:
a fry rack for securing the food item to be fried inside the cauldron, the fry rack comprising:
a base with a plurality of holes; and
a plurality of handles extending from the base.

8. The apparatus of claim 1 wherein said liquid is water and the apparatus is used to steam food items placed inside the cauldron further comprising:
a plurality of perforated trays for supporting a food item to be steamed and allowing steam to rise there through.

9. An apparatus comprising:
an elliptical cauldron for containing a liquid and a food item to be heated;
an overflow sleeve, coupled to said cauldron, for receiving liquid overflow and condensate from the cauldron, the overflow sleeve having a drain outlet; and
a drain basin, having an inlet for receiving overflow from the overflow sleeve.
